(19) United States
(12) Patent Application Publication
(10) Pub. No.: US 2007/0118863 A1
(43) Pub. Date: May 24, 2007

(54) Apparatus and method for controlling household electronic appliances using broadcasting middleware in home network environment

(75) Inventors: Young-Sung Son, Daejon (KR); Jun-Hee Park, Daejon (KR); Kyeong-Deok Moon, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(73) Assignee: Electronics and Telecommunications Research Institute

(21) Appl. No.: 11/485,759

(22) Filed: Jul. 12, 2006

(30) Foreign Application Priority Data
Nov. 24, 2005 (KR) 10-2005-0112871

(51) Int. Cl. H04N 7/00; H04N 7/16; H04N 7/173; H04N 11/00; H04N 7/18

(52) U.S. Cl. 725/80; 725/133; 725/141; 348/552; 348/460

(57) ABSTRACT

Provided are an apparatus and a method for controlling household electronic appliances using a broadcasting middleware in a home network environment. The apparatus, includes: a data separator for receiving broadcasting signals in a broadcasting receiving unit and separating broadcasting data and control data out of the broadcasting signals; a broadcasting data analyzer for analyzing the control data obtained in the data separator; an application program executor for executing an application program based on the control data analyzed in the broadcasting data analyzer; and a home network controller for receiving a control command from the application program executer and controlling the household electronic appliances of a home network.

### FIELD OF THE INVENTION

The present invention relates to an apparatus for controlling household electronic appliances supporting a control middleware in a home network environment by using a broadcasting middleware, and a method thereof; and, more particularly, to an apparatus for controlling household electronic appliances using a broadcasting middleware in a home network environment by transforming the control data for controlling household electronic appliances and the household electronic appliances in the home network receiving broadcasting signals together with broadcasting data, and processing the broadcasting signals in a set-top box, which is a broadcasting middleware of a system for processing the broadcasting signal so that the user use broadcasting data and control data, i.e., a service program, in the same method.

### DESCRIPTION OF RELATED ART

There are two methods for controlling household electronic appliances in a conventional home network environment. One is to control a fixed terminal through wire or wirelessly through the Internet and perform data communication between a mobile terminal and the fixed terminal controlling the household electronic appliances. The other is to control and monitor each electronic home appliance with a user terminal by individually setting up a server system to provide a home network service.

However, since the conventional methods require to individually set up a control device to control the household electronic appliances in the home network environment and be individually equipped with a management device to manage the control device, there is a problem that the system is large due to additional devices added to the home network system.

### SUMMARY OF THE INVENTION

It is, therefore, an object of the present invention to provide an apparatus and method for controlling household electronic appliances using a broadcasting middleware in a home network environment, which controls household electronic appliances through a home network by collecting and using information on household electronic appliances, processing control data, i.e., a service program, in a broadcasting middleware, which processes a broadcasting signal so that users can use the broadcasting signals in the same method as they use broadcasting data.

Other objects and advantages of the invention will be understood by the following description and become more apparent from the embodiments in accordance with the present invention, which are set forth hereinafter. It will be also apparent that objects and advantages of the invention can be embodied easily by the means defined in claims and combinations thereof.

In accordance with an aspect of the present invention, there is provided an apparatus for controlling household electronic appliances using a broadcasting middleware in a home network environment, the apparatus including: a data separator for receiving broadcasting signals in a broadcasting receiving unit and separating broadcasting data and control data out of the broadcasting signals; a broadcasting data analyzer for analyzing the control data obtained in the data separator; an application program executor for executing an application program based on the control data analyzed in the broadcasting data analyzer; and a home network controller for receiving a control command from the application program executer and controlling the household electronic appliances of a home network.

In accordance with another aspect of the present invention, there is provided a method for controlling household electronic appliances using a broadcasting middleware in a home network environment, the method including the steps of: a) initializing a system of a broadcasting receiving unit, receiving broadcasting signals and separating the broadcasting signals into broadcasting data and control data; b) determining a kind of the control data by transmitting the broadcasting data among the broadcasting data and the control data to a broadcasting.middleware, restoring the broadcasting data, and executing the control data in an application program execution engine; and c) controlling the household electronic appliances by connecting the control data to an embedded home network application program when the control data are of a TV user interface application program, and controlling the household electronic appliances by connecting the control data to a command execution module of the home network application program when the control data are of a broadcasting control application program.

### BRIEF DESCRIPTION OF THE DRAWINGS

The above and other objects and features of the present invention will become apparent from the following description of the preferred embodiments given in conjunction with the accompanying drawings, in which:

FIG. 1 is a diagram describing a household electronic appliances controlling apparatus using a broadcasting middleware in a home network environment in accordance with an embodiment of the present invention;

FIG. 2 is a block diagram illustrating the household electronic appliances controlling apparatus using the broadcasting middleware in the home network environment in accordance with the embodiment of the present invention;

FIGS. 3A and 3B are block diagrams showing a connection relationship between an application program execution engine of the household electronic appliances controlling apparatus and a home network control unit in the home network environment in accordance with the embodiment of the present invention;

FIGS. 4A to 4D are exemplary views showing TV screens obtained by using the household electronic appliances controlling apparatus in the home network environment in accordance with an embodiment of the present invention; and

FIG. 5 is a flowchart describing a household electronic appliances controlling method using the broadcasting middleware in the home network environment in accordance with an embodiment of the present invention.

### DETAILED DESCRIPTION OF THE INVENTION

Other objects and advantages of the present invention will become apparent from the following description of the embodiments with reference to the accompanying drawings. Therefore, those skilled in the art that the present invention is included can embody the technological concept and scope of the invention easily. In addition, if it is considered that detailed description on the related art may obscure the points of the present invention, the detailed description will not be provided herein. The preferred embodiments of the present invention will be described in detail hereinafter with reference to the attached drawings.

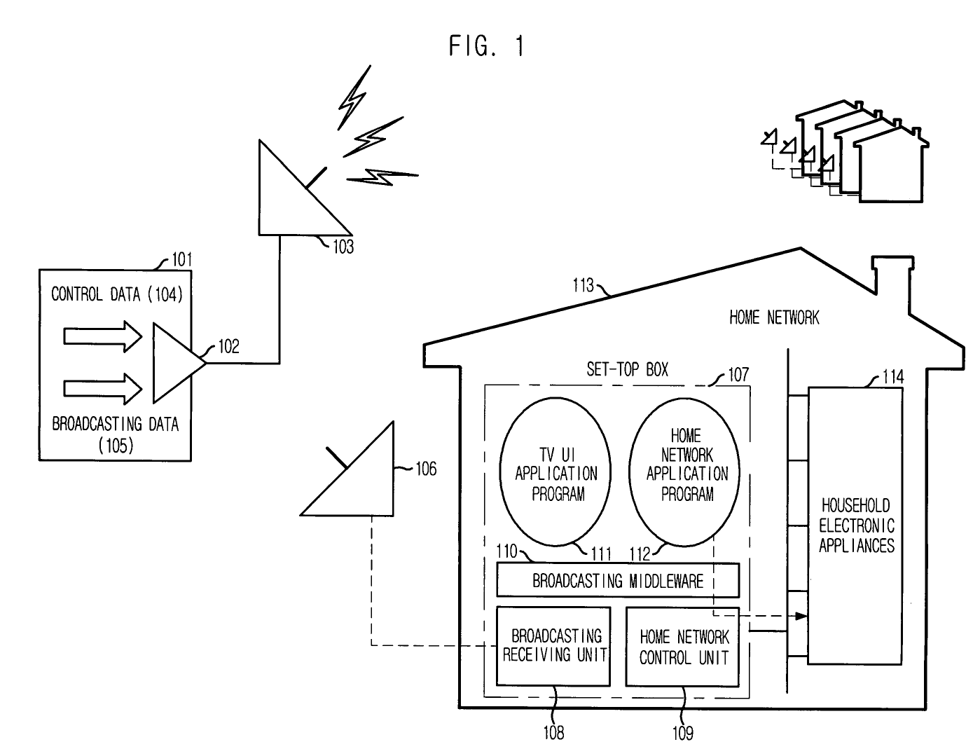

FIG. 1 is a diagram describing a household electronic appliances controlling apparatus using a broadcasting middleware in a home network environment in accordance with an embodiment of the present invention. It shows a physical environment of a broadcasting and home network.

As shown in FIG. 1, a broadcasting system includes a broadcasting transmitting unit 101, a broadcasting transmitter 103, a broadcasting receiver 106 and a broadcasting receiving unit 108.

The broadcasting transmitting unit 101 transmits a control data 104 and a broadcasting data 105 in the form of broadcasting signals.

The broadcasting transmitter 103 transmits the broadcasting signal outputted from the broadcasting transmitting unit 101. The broadcasting receiver 106 receives the broadcasting signal outputted from the broadcasting transmitter 103. The broadcasting receiving unit 108 processes the signal transmitted from the broadcasting receiver 106.

The home network environment includes a home network control unit 109 and a home network 113.

The home network control unit 109 collects and manages information on household electronic appliances 114. The home network 113 connects the household electronic appliances 114.

Meanwhile, a set-top box 107 connecting the broadcasting environment with the home network environment shows that a broadcasting middleware 110, a TV user interface (UI) application program 111 and a home network application program 112 of the home network 113 are in operation.

Herein, the broadcasting middleware 110 recognizes the control data 104 as the broadcasting data 105 and synthetically manages the control data 104. The TV UI application program 111 is an application program of the broadcasting middleware 110.

The broadcasting transmitting unit 101 includes a data scrambler 102 for transforming the broadcasting data 105 and the control data 104 into broadcasting signals. Herein, the broadcasting data 105 includes image and image-related information, and the control data 104 controls household electronic appliances.

Informations on diverse household electronic appliances 114 connected to the home network are collected in the home network control unit 109 and managed by a home network database.

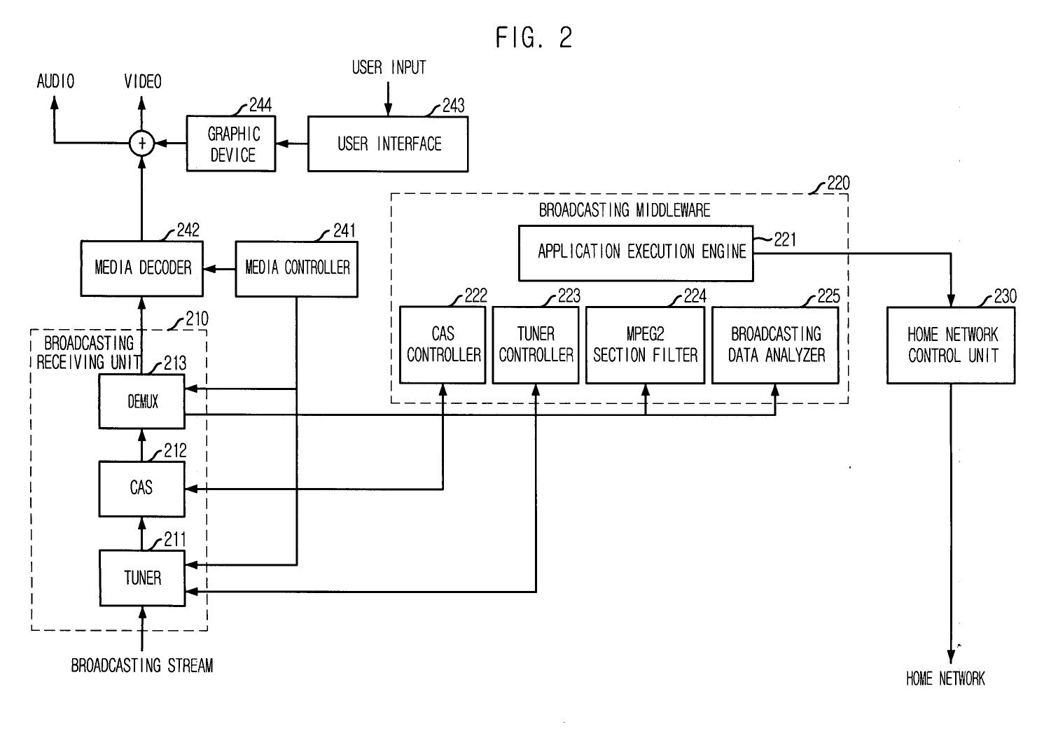

FIG. 2 is a block diagram illustrating a household electronic appliances controlling apparatus using a broadcasting middleware in a home network environment in accordance with the embodiment of the present invention. It shows a formation of the set-top box 107 which is in charge of a major role.

As shown in FIG. 2, the household electronic appliances controlling apparatus using a broadcasting middleware of the present invention has the same structure as a general broadcasting receiver. However, the household electronic appliances controlling apparatus further includes a part for separating control data and broadcasting data from the transmitted broadcasting data, and controlling the household electronic appliances connected to the home network based on the control data.

The general broadcasting receiver will be described in detail hereinafter.

The general broadcasting receiver includes a tuner 211, a Conditional Access System (CAS) 212, a demultiplexer 213, a media decoder 242, a broadcasting middleware 220, a user interface 243 and a graphic device 244.

The tuner 211 selects a specific channel through a tuner controller 223 of the in broadcasting stream inputted into a broadcasting receiving unit 210. Also, the tuner 211 receives and demodulates a broadcasting signal of a frequency band mapped to the channel. The tuner 211 also generates Moving Picture Experts Group 2 (MPEG-2) transmission stream (TS) through a media controller 241.

The CAS 212 is controlled by a CAS controller 222 of the broadcasting middleware 220 such that only a receiver approved for a pay broadcasting service can receive the transmission stream outputted from the tuner 211.

The demultiplexer 213 separates an audio/video (AV) and additional information and control data to be transmitted to a broadcasting data analyzer 225 of the broadcasting middleware 220 out of the transmission stream outputted from the CAS 212 based on Program Specific Information/Program and system information protocol (PSI/PSIP) information.

The media decoder 242 decodes the AV information obtained in the demultiplexer 213, and the broadcasting middleware 220 analyzes the additional information.

The user interface 243 processes the user input and the graphic device 244 displays contents of the user interface 243.

Therefore, the household electronic appliances controlling apparatus of the present invention uses the set-top box as described above.

The household electronic appliances controlling apparatus is as follows to control the household electronic appliances based on the broadcasting middleware.

The broadcasting transmitter includes a data scrambler 102 scrambling broadcasting data and control data for household electronic appliances control.

The broadcasting receiving unit 210 includes a demultiplexer 213, a broadcasting data analyzer 225, an application execution engine 221 and a home network control unit 230.

The demultiplexer 213 receives broadcasting signals and divides the broadcasting signal into the broadcasting data and the control data.

The broadcasting data analyzer 225 receives the control data obtained in the demultiplexer 213 and analyzes the control data.

The application execution engine 221 executes an application program based on the control data of the broadcasting data analyzer 225.

The home network control unit 230 receives a control command of the application execution engine 221 and controls the household electronic appliances of the home network.

The control data are transmitted to the broadcasting data analyzer 225 and the rest data are transmitted to the module for processing the broadcasting data.

The broadcasting middleware 220, which are divided into a broadcasting data processing unit and a control data processing unit, also includes an MPEG-2 section filter 224.

The control data processing unit has a broadcasting data analyzer 225 and executes the TV user interface application program 111 or the home network application program 112 in the application program execution engine 221 by collecting the control data.

The home network control unit 230 includes a home network database for collecting and storing household electronic appliances condition information on the home network.

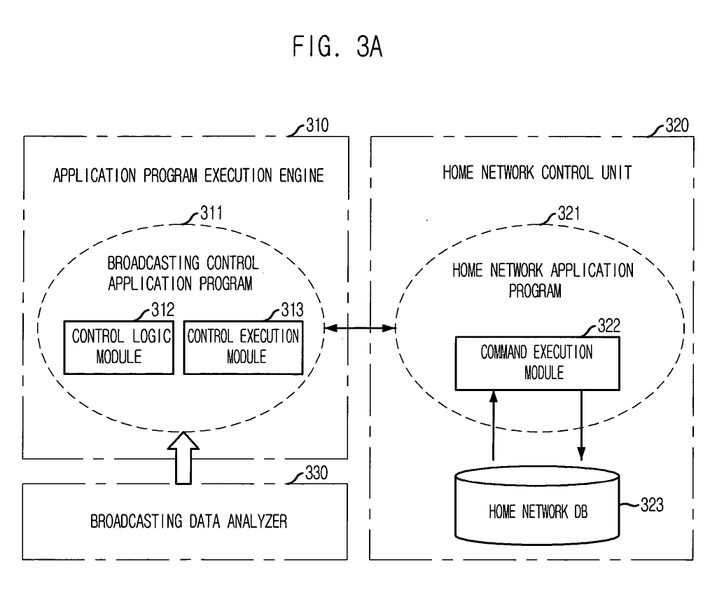

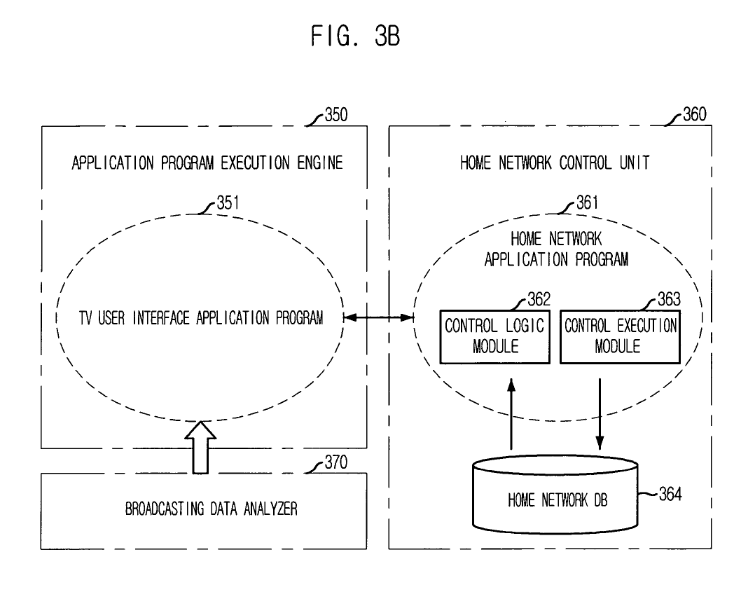

FIGS. 3A and 3B are block diagrams showing a connection relationship between an application program execution engine of the household electronic appliances controlling apparatus and a home network control unit in the home network environment in accordance with the embodiment of the present invention.

The diverse broadcasting-related TV user interface application programs 111 can be operated in an application program execution engine 310.

FIG. 3A shows a case that a control logic module 312 and a control execution module 313, which are related to the household electronic appliances control, are included in the inside of a broadcasting control application program 311 among the application program execution engine 310.

The TV user interface application program 111 is executed by collecting the control data in the broadcasting data analyzer 330. In this case, a control command is formed in the control logic module 312 and the control execution module 313, which are inside processes. Subsequently, the control command is transmitted to a command execution module 322 of a home network application program 321 based on a home network DB 323 in a home network control unit 320 and the control command of the command execution module 322 is executed in the home network.

FIG. 3B shows a case that only a TV user interface application program 351 is included in the application program among an application program execution engine 350. Also, it shows that a control logic module 362 and a control execution module 363, which are related to the actual household electronic appliances control, are included in an embedded home network application program 361 which is executed in a home network control unit 360 based on a home network DB 364.

The TV user interface application program 351 is executed in a broadcasting data analyzer 370 by collecting the control data.

In the above case, the TV user interface application program 351 transmits a command for controlling an embedded home network application program 361. Also, the control command is formed in the control logic module 362 and the control execution module 363, which are internal processes of the embedded home network application program 361 and is operated in the home network.

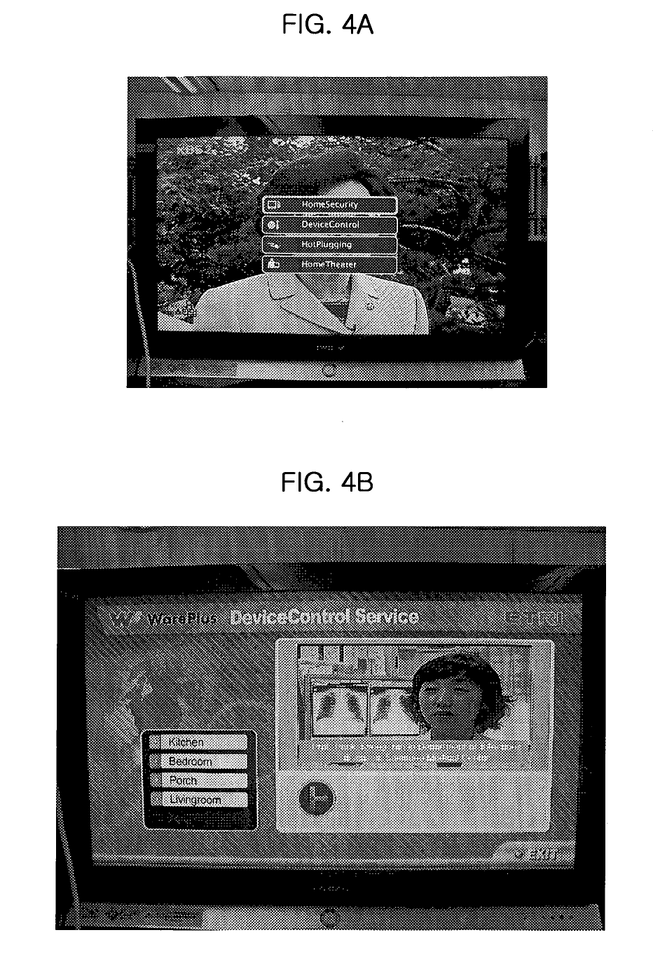

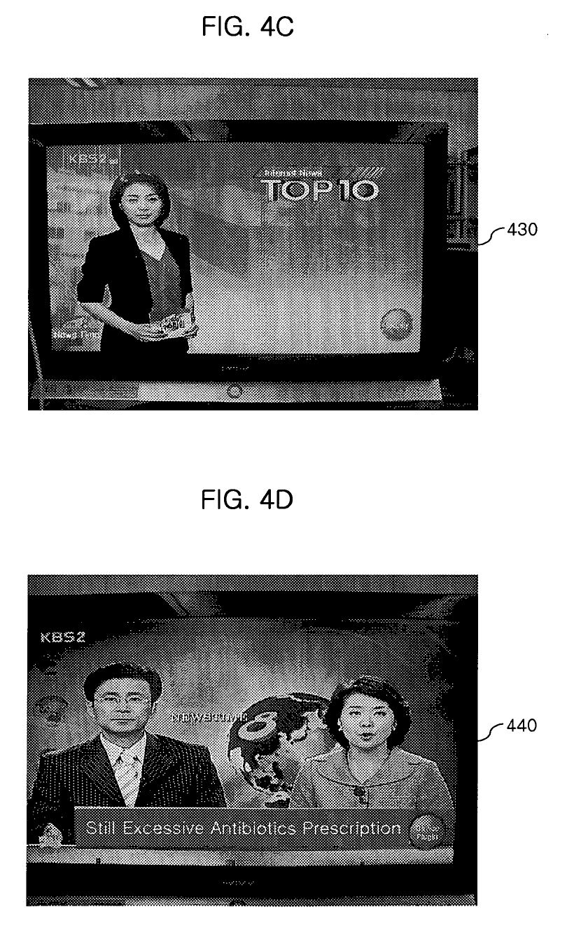

FIGS. 4A to 4D are views showing TV screens using the household electronic appliances controlling apparatus using the broadcasting middleware in the home network environment in accordance with an embodiment of the present invention.

That is, the household electronic appliances controlling apparatus provides information to the user by providing information changes in the home network and the service through the screen in real-time. The user can control and monitor the household electronic appliances of the home network through the screen.

FIG. 4A is an exemplary view of the TV screen showing a list of available broadcasting services and home network services. It shows available broadcasting data application programs and home network application programs in an application program execution engine, on the screen as a list.

FIG. 4B is an exemplary view of the TV screen showing a condition of the home network service by executing the control data of the household electronic appliances. Since the present broadcasting is continuously operated in a part of the screen and a home appliances control screen is also shown on the screen, the user can control the household electronic appliances.

FIG. 4C shows that a service condition change 430 in the home network is on the screen in real-time such that the user can recognize the service condition change and control the service.

FIG. 4D shows that a service condition change 440 in the home network is on the screen in real-time such that the user can recognize the service condition change and control the service.

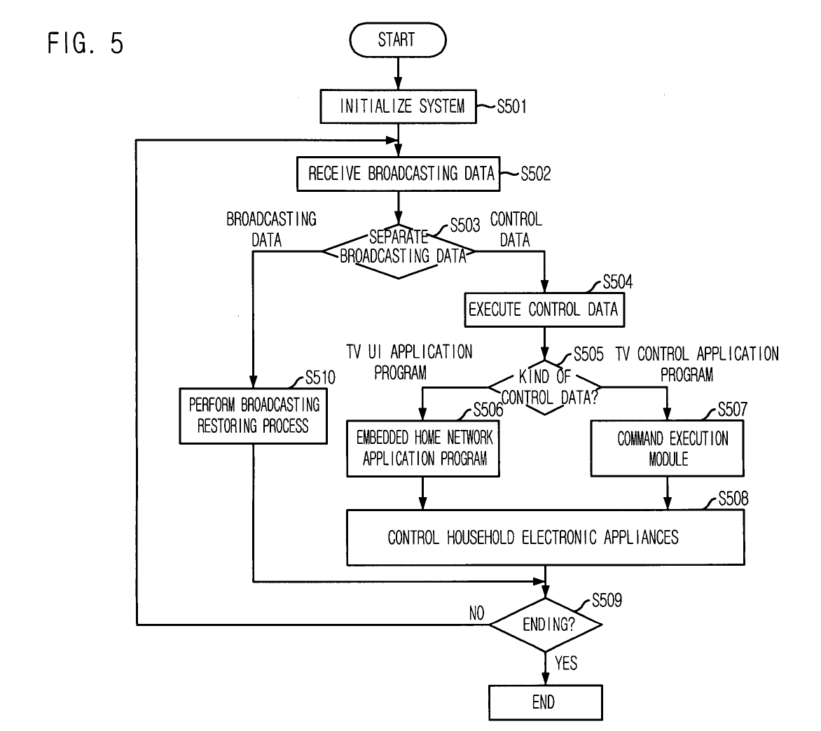

FIG. 5 is a flowchart describing a household electronic appliances controlling method using the broadcasting middleware in the home network environment in accordance with an embodiment of the present invention.

As shown in FIG. 5, the household electronic appliances controlling method using the broadcasting middleware in the home network environment includes steps of initializing a system of the broadcasting receiving unit at step S501, receiving broadcasting data at step S502 and dividing the transmitted broadcasting data into broadcasting data and control data at step S503.

In the separated broadcasting data and control data, the broadcasting data are transmitted to the broadcasting middleware and a broadcasting restoring process is performed at step S510. The control data are executed in the application program execution engine at step S504 and the kind of control data is determined at step S505.

When it turns out that the control data are of the TV user interface application program, the control data connects a household electronic appliance to the embedded home network application program at step S506 and controls the household electronic appliance at step S508. When it turns out that the control data are of the broadcasting control application program, the control data connects a household electronic appliance to a command execution module of the home network application program at step S507 and controls the household electronic appliances at step S508.

The present invention has the control data, i.e., service program, which is set up through the broadcasting in the home network environment of each home where there are diverse household electronic appliances, control the household electronic appliances based on the home network information. Accordingly, the user can control the household electronic appliances by the method for operating the broadcasting data and a home network service provider can easily provide massive home network services through broadcasting.

As described in detail, the technology of the present invention can be realized as a program and stored in a computer-readable recording medium, such as CD-ROM, RAM, ROM, a floppy disk, a hard disk and a magneto-optical disk. Since the process can be easily implemented by those skilled in the art of the present invention, further description will not be provided herein.

The present application contains subject matter related to Korean patent application No. 2005-0112871, filed with the Korean Intellectual Property Office on Nov. 24, 2005, the entire contents of which are incorporated herein by reference.

While the present invention has been described with respect to certain preferred embodiments, it will be apparent to those skilled in the art that various changes and modifications may be made without departing from the scope of the invention as defined in the following claims.

What is claimed is:

1. An apparatus for controlling household electronic appliances using a broadcasting middleware in a home network environment, comprising:
a data separating means for receiving broadcasting signals in a broadcasting receiving unit and separating broadcasting data and control data out of the broadcasting signals;
a broadcasting data analyzing means for analyzing the control data obtained in the data separating means;
an application program executing means for executing an application program based on the control data analyzed in the broadcasting data analyzing means; and
a home network controlling means for receiving a control command from the application program executing means and controlling the household electronic appliances of a home network.

2. The apparatus as recited in claim 1, further comprising:
a data scrambling means for scrambling the broadcasting data and the control data for controlling the household electronic appliances in a broadcasting transmitter.

3. The apparatus as recited in claim 1, wherein the data separating means transmits the broadcasting data obtained from the separation to a module for processing the broadcasting data.

4. The apparatus as recited in claim 3, wherein the application program executing means executes a broadcasting-related TV user interface application program and a home network application program based on the control data.

5. The apparatus as recited in claim 3, wherein the home network controlling means includes:
a home network database for collecting and storing information on state of the household electronic appliances in the home network.

6. The apparatus as recited in claim 3, wherein the application program executing means is the TV user interface application program executed on the home network by collecting the control data from the broadcasting data analyzing means, forming a control command in a control logic module and a control execution module, which are internal processes, transmitting the control command to a command execution module of the home network application program in the home network controlling means, and executing the control command of the command execution module on the home network.

7. The apparatus as recited in claim 3, wherein the application program executing means is the TV user interface application program executed on the home network by collecting the control data from the broadcasting data analyzing means, transmitting a command for controlling an embedded home network application program, forming a control command in a control logic module and a control execution module, which are internal processor of the embedded home network application program, and executing the control command on the home network.

8. The apparatus as recited in claim 3, wherein the household electronic appliances controlling apparatus using the broadcasting middleware provides information change on the home network and information change of the service to the user through a screen in real-time, and the user controls and monitors the household electronic appliances on the home network through the screen.

9. A method for controlling household electronic appliances using a broadcasting middleware in a home network environment, comprising the steps of:
a) initializing a system of a broadcasting receiving unit, receiving broadcasting signals and separating the broadcasting signals into broadcasting data and control data;
b) determining a kind of the control data by transmitting the broadcasting data among the broadcasting data and the control data to a broadcasting middleware, restoring the broadcasting data, and executing the control data in an application program execution engine; and
c) controlling the household electronic appliances by connecting the control data to an embedded home network application program when the control data are of a TV user interface application program, and controlling the household electronic appliances by connecting the control data to a command execution module of the home network application program when the control data are of a broadcasting control application program.
